(19) United States
(12) Patent Application Publication
(10) Pub. No.: US 2022/0284920 A1
(43) Pub. Date: Sep. 8, 2022

(54) A METHOD AND A NOISE INDICATOR SYSTEM FOR IDENTIFYING ONE OR MORE NOISY PERSONS

(71) Applicant: GN AUDIO A/S, Ballerup (DK)

(72) Inventors: Michael Hoby ANDERSEN, Ballerup (DK); Lars Dam BOLDT, Ballerup (DK)

(21) Appl. No.: 17/597,403

(22) PCT Filed: Jul. 3, 2020
(86) PCT No.: PCT/EP2020/068836

§ 371 Date: Jan. 5, 2022

(30) Foreign Application Priority Data
Jul. 5, 2019 (DK) PA 2019 00840

(51) Int. Cl. G10L 25/78; G10L 17/02; H04R 5/04; H04R 5/033

(52) U.S. Cl. CPC G10L 25/78; G10L 17/02; H04R 5/04; H04R 5/033; G10L 2025/783

(57) ABSTRACT

A method for identifying one or more noisy persons speaking in an open office or other open workplace environment, the method comprising; measuring acoustic level of speech in the workplace environment, analysing the voice characteristics of the persons speaking in order to distinguish the different speakers, estimating acoustic noise levels for each of the one or more persons speaking. A noise indicator system for identifying one or more noisy person(s) speaking in an open office or other open workplace environment comprising one or more microphones, a voice analyzer configured for analyzing voices recorded by the microphone(s), a noise level estimator configured for estimating the noise level of the voices, a data logging unit configured for recording and storing voice level data, a voice mapping unit configured for comparing recorded voice data with voice data stored in a voice profile data bank.

### FIELD OF INVENTION

The present invention relates to a method and a noise indicator system for identifying one or more noisy persons speaking in an open office or other open workplace environment. The invention may advantageously be applied in connection with systems comprising multiple personal audio communication devices, such as e.g. headsets and headset base stations, speakerphones, telephones such as smartphones and other mobile phones, tablets and personal computers comprising audio components such as microphones and loudspeakers.

### BACKGROUND

As noise in office environments is often caused by noisy behavior of people in the room, most noise is related to people talking with a raised voice without considering the immense inconvenience they cause by disturbing their colleagues trying to concentrate on their own work tasks.

The Jabra Noise Guide is a product for use in open office environments, that measures the noise using built-in microphones and optionally a number of satellite microphones and configured to indicate with three colors—green, yellow and red—the amount of noise in the room. It will light red whenever the noise exceeds a set limit, and thus indicate to the noisy persons that they should either be quieter or find another place to continue talking, as they are disturbing their colleagues. The Jabra Noise Guide may be set up with multiple microphone units distributed in a room or a suite of rooms, such as e.g. an open office or a workshop or other open workplace environment where a group of people communicate through speech during the work day. One or more display units may be located in the same room or suite of rooms. Each microphone unit measures acoustic noise levels at its location and transmits the measured acoustic noise levels to one or more of the display units, which display the current noise level in a symbolic fashion. The noise indication system gives visual feedback about the noise levels, thereby making office and workshop workers aware of their own noise contribution, which may generally aid in lowering the overall noise level. Ideally, each office desk or work location should be equipped with a microphone unit. In larger offices or rooms with many workers, the microphone units may thus make the noise indication system rather expensive, and they may further contribute to cluttering of desktops and workbenches.

A further development of this type of noise indication system is known from European patent EP 2863655 B1 disclosing a method for estimating acoustic noise levels, the method comprising for each of two or more audio communication devices, receiving an acoustic signal from ambient space and providing a corresponding microphone output signal by a microphone comprised by the respective audio communication device and repeatedly estimating a local acoustic noise level in dependence on the microphone output signal and repeatedly estimating a location-dependent distribution of acoustic noise levels in ambient space in dependence on the local acoustic noise levels. The system utilizes personal communication equipment such as e.g. headsets and headset base stations or telephones such as mobile phones, for recording personal voice of the users of this equipment through their built-in microphones.

The prior art systems do however not provide personal noise level estimates associated with each person present in the specific working environment as these systems do not recognize individual voices but merely indicate noise levels generally in the room or office, or more specifically as a location-dependent distribution of acoustic noise levels based on the location of the used microphones.

### SUMMARY

It is therefore an object of the present invention to provide respectively a method for identifying one or more noisy persons speaking in an open office or other open workplace environment and a noise indicator system for identifying one or more noisy persons speaking in the open office or other open workplace environment.

According to the invention a method for identifying one or more noisy persons speaking in an open office or other open workplace environment is provided, the method comprising; measuring acoustic level of speech in the workplace environment, analysing the voice characteristics of the persons speaking in order to distinguish the different speakers, estimating acoustic noise levels for each of the one or more persons speaking, thereby being able to give personal feed-back to persons speaking above a predetermined noise level with the aim of improving the individual person's behavior in the workplace environment.

The method may further comprise estimating the acoustic noise levels for each of the one or more persons speaking by providing accumulated acoustic speech level measurements during a predetermined period of time thereby providing a more advanced and precise identification of the one or more noisy persons.

The method may further comprise logging the acoustic noise level measurements associated with persons that have spoken with a voice level above a predetermined noise level threshold, and the amount of time their speech level has been above the set threshold. In that way a record can be held of have often and for how long time specific persons have been talking too loudly. Especially if the method further comprises logging voice level data in a noise indicator system, and when needed for evaluation, retrieving noise level data from the noise indicator system, it will then be possible to retrieve the data from the sound indicator system, and thereby see which persons have been talking too loud, and for how long, during a given period—hours, days, weeks, months etc.

The method may further comprise recording voice samples of one or more persons among a group of people present in an open workplace environment and storing these voice samples in a bank of user voice profiles for later comparison with noise/voice measurements from the workplace environment making an identification of the noisy person(s) easier.

It is an advantage if the method further comprises mapping the measured and analysed speech to a specific person, by comparing speech characteristics to a bank of user voice profiles comprising prerecorded speech characteristics of the persons in the office environment.

In an embodiment of the method, analyzing the speech characteristics of a person is done using a headset in the office environment by recording the voice of the user through the microphone of the headset and creating and storing the user's voice profile in the bank of user voice profiles.

The method may further comprise recording a small sample of speech along with the speech level mapping, subsequently identifying the speaker by listening to the small segment of recorded speech. It is an advantage that this can be monitored by for example a superior or manager with the purpose of when needed giving feedback to the noisy person and thereby improve his or her behavior in the open workplace environment.

To improve the voice profile databank, the method may further comprise adding new voice profiles or voice profile characteristics to the voice profile databank based on the mapped voice samples.

According to a further aspect of the invention a noise indicator system for identifying one or more noisy person(s) speaking in an open office or other open workplace environment is provided. The system comprises one or more microphones a voice analyzer configured for analyzing voices recorded by the microphone(s), a noise level estimator configured for estimating the noise level of the voices, a data logging unit configured for recording and storing voice level data, a voice mapping unit configured for comparing recorded voice data with voice data stored in a voice profile databank. The noise indicator system is especially suitable for carrying out the method described above and thus provides the same benefits and advantages.

It is an advantage that the noise indicator system comprises a data exchange interface for connecting and exchanging recorded voice data with external devices. Thereby the recorded data may be stored and further processed at external devices with larger capacity such as personal computers or data servers.

The noise indicator system may further comprise a noise indicator housing wherein the microphones are mounted, or external microphones may be connected to the noise indicator housing either by cable or wirelessly.

The noise indicator system may comprise a voice profile databank for storing voice profile data. The voice profile databank may be connected to a voice sample database.

The voice profile databank and/or the voice sample database may be stored at a remote server such as at a cloud service to provide more storage capacity and to make access to the data in the system easier to a superior or manager.

It is a further advantage if the system further comprises a display for indicating current and/or accumulated noise levels. The display may be physically placed within the noise identifier housing or connected through a cable or be a wireless display connected through the data exchange interface. The display may be the display of the user's or a manager's smartphone, tablet or PC screen.

### BRIEF DESCRIPTION OF THE DRAWINGS

The above and other features and advantages will become readily apparent to those skilled in the art by the following detailed description of exemplary embodiments thereof with reference to the attached drawings, in which:

FIG. 1 schematically illustrates an exemplary noise indicator system 1 according to the present invention.

FIG. 2 shows a flowchart 50 of a method according to the present invention.

### DETAILED DESCRIPTION

Various embodiments are described hereinafter with reference to the figures. Like reference numerals refer to like elements throughout. Like elements will, thus, not be described in detail with respect to the description of each figure. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described. Throughout, the same reference numerals are used for identical or corresponding parts.

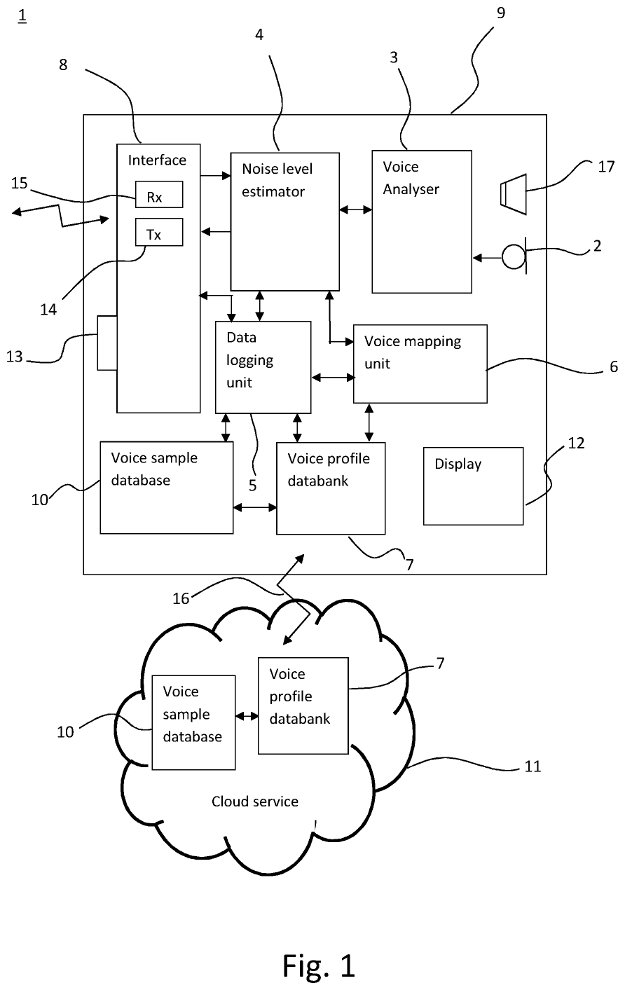

FIG. 1 schematically illustrates an exemplary noise indicator system 1 according to the present invention. The noise indicator system is configured for identifying one or more noisy person(s) speaking in an open office or other open workplace environment. The system comprises one or more microphones 2, a voice analyzer 3 configured for analyzing voices recorded by the microphone(s) 2, a noise level estimator 4 configured for estimating the noise level of the voices analyzed, a data logging unit 5 configured for recording and storing voice level data, comprising a memory circuit such as a an EEPROM or a flash memory, a voice mapping unit 6 configured for comparing recorded voice data with voice data stored in a voice profile databank 7, a data exchange interface 8 for connecting and exchanging recorded voice data with external devices. The interface 8 might include an electrical connector 13, such as an ethernet or USB interface and/or a wireless interface such as Bluetooth or Wi-Fi comprising a RF circuit with transmitter 14 and receiver 15. The interface 8 also being configured for internal data communication with the noise level estimator 4 and the data logging unit 5. Further, the data logging unit 5 may be configured for internal data communication with the voice mapping unit 6, the voice profile databank 7 and the voice sample database 10.

The voice analyzer 3 may require “training” where individual speakers read text or record normal speaking voice samples into the system. The system analyzes the person's specific voice and uses it to fine-tune the recognition of that person's speech, resulting in increased accuracy. This is also used to improve the voice profile databank 7.

Speech characteristics used to map recorded voice to voice profiles in the databank 7 may comprise volume, pace, pitch, resonance, articulation, enunciation, respiration, pauses, length of consonants, vowels, syllables, register, timbre, or vocal quality (e.g. tinny, shrill, fatigued, breathy), tone (emotional quality), variations in pitch (e.g. melody or intonation), elision, paralinguistic utterances such as crying, laughing, screaming or other non-word vocalizations that have meaning.

The noise indicator system 1 might comprise a housing 9 wherein the microphone(s) 2 might be mounted as shown in FIG. 1 or they might in another embodiment be external microphones connected through interface 8 either by cable to electrical connector 13 or wirelessly connected via interface 14, 15 to the noise indicator housing 9.

In an embodiment the one or more microphones are mounted in an audio communication headset (not shown) worn by a user in the open workplace environment and configured for recording the speech of the headset user.

In FIG. 1 it is also disclosed that optionally the voice profile databank 7 and/or the voice sample database 10 can be stored at a remote server such as at a cloud service 11 connected to the noise indicator housing 9 through a wired or wireless data network 16, e.g. via the data exchange interface 8, such as Wi-Fi, LAN or WAN which might also provide a further connection to the internet.

The noise indicator system 1 may comprise a display 12 for indicating current and/or accumulated noise levels for each identified person either by colours or symbols etc. The display 12 may be physically placed within the noise identifier housing 9 or connected through a cable or be a wireless display connected through interface 8. The display 12 may be the display of the user's smartphone, tablet or PC screen.

Further, a loudspeaker 17 may give personalized feed-back to the identified noisy person so that he or she can improve the behavior in the workplace environment. The loudspeaker 17 may as shown in FIG. 1 be physically placed within the noise identifier housing 9 or connected through a wire or be a wireless loudspeaker connected through interface 8. The loudspeaker may for example be the speaker of an audio communication headset worn by the user or a speakerphone device located at the user's desk.

Voice level data may be logged in in the data logging unit 5 within the noise indicator system 1, and when needed for evaluation, retrieving the noise level data from the noise indicator system through the interface 8.

The voice sample database 10 may store prerecorded voice samples of one or more persons among a group of people present in the open workplace environment and the voice profile databank 7 may store speech characteristics of the persons in the office environment for later comparison with noise/voice measurements from the workplace environment.

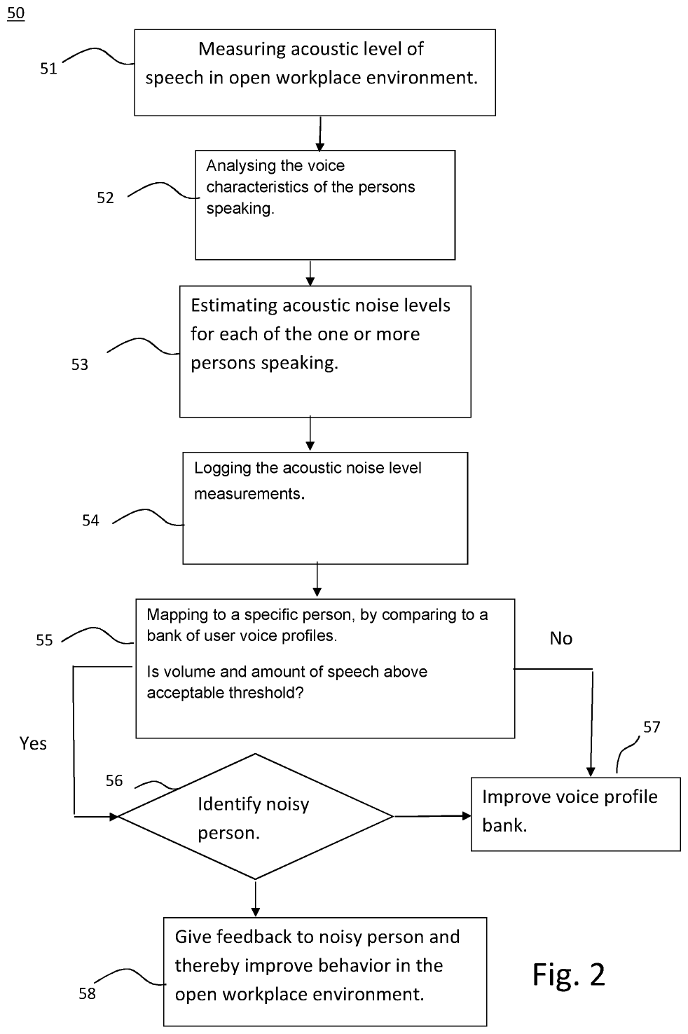

In FIG. 2, a flowchart 50 is shown, illustrating a method according to the present invention and suitable for being performed in the noise indicator system 1 disclosed in FIG. 1.

The embodiment of the method comprises the following steps: In step 51, measuring acoustic level of speech in an open workplace environment by using one or more microphones 2 either mounted internally in the noise indicator housing 9 or externally connected. This may be done by recording the voice of the user through the microphone of a headset worn by the user.

In step 52, analysing the voice characteristics of the persons speaking in order to distinguish the different speakers. In step 53, estimating acoustic noise levels for each of the one or more persons speaking. This may be done as momentary measurements of noise level or estimating the acoustic noise levels for each of the one or more persons by providing accumulated acoustic speech level measurements during a predetermined period of time.

In step 54, logging the acoustic noise level measurements in a memory. In step 55 mapping the recorded and analyzed voice to a specific person by comparing voice measurement to a bank of user voice profiles, and in step 56, if the volume and amount of speech is above an acceptable threshold, then identifying the noisy person.

If the recorded voice cannot be mapped to a specific person, then optionally in step 57 saving a sample of the recorded speech and creating a new voice profile of an unknown person in the voice profile databank 7. Regardless of whether the speech level is acceptable or not the voice profile databank 7 can be improved by adding the recorded sample of speech to the specific voice profile of the mapped person. Finally, also as an option in step 58, giving feed-back to the noisy person identified and thereby improve the persons behavior in the open workplace environment.

In step 54 further logging might be done of the acoustic noise level measurements associated with persons that have spoken with a voice level above a predetermined noise level threshold, and the amount of time their speech level has been above the set threshold.

The user's voice profile might be created using the recorded speech through the headset microphone and subsequently stored as a voice profile in the voice profile databank 7.

The method may further comprise recording a small sample of speech along with the speech level mapping, subsequently identifying the speaker by listening to the small segment of recorded speech. This can e.g. be done by a supervisor or manager responsible for the persons working in the open workplace environment.

Although particular features have been shown and described, it will be understood that they are not intended to limit the claimed invention, and it will be made obvious to those skilled in the art that various changes and modifications may be made without departing from the scope of the claimed invention. The specification and drawings are, accordingly, to be regarded in an illustrative rather than restrictive sense. The claimed invention is intended to cover all alternatives, modifications and equivalents.

### LIST OF REFERENCES

1 Noise indicator system
2 Microphone(s)
3 Voice analyzer
4 Noise level estimator
5 Data logging unit
6 Voice mapping unit
7 Voice profile databank
8 Data exchange interface
9 Noise indicator housing
10 Voice sample database
11 Cloud service
12 Display
13 Electrical connector
14 Transmitter
15 Receiver
16 Data network
17 Loudspeaker

1. A method for identifying one or more noisy persons speaking in an open office or other open workplace environment, the method comprising; measuring acoustic level of speech in the workplace environment, analysing the voice characteristics of the persons speaking in order to distinguish the different speakers, estimating acoustic noise levels for each of the one or more persons speaking.

2. A method according to claim 1, wherein estimating the acoustic noise levels for each of the one or more persons speaking is done by providing accumulated acoustic speech level measurements during a predetermined period of time.

3. A method according to claim 1, further comprising logging the acoustic noise level measurements associated with persons that have spoken with a voice level above a predetermined noise level threshold, and the amount of time their speech level has been above the set threshold.

4. A method according to claim 1, further comprising logging voice level data in a noise indicator device, and when needed for evaluation, retrieving noise level data from the noise indicator device.

5. A method according to claim 1, further comprising recording voice samples of one or more persons among a group of people present in an open workplace environment and storing these voice samples in a database of user voice samples for later comparison with noise/voice measurements from the workplace environment.

6. A method according claim 1 further comprising mapping the measured and analysed speech to a specific person, by comparing speech characteristics to a bank of user voice profiles comprising prerecorded speech characteristics of the persons in the office environment.

7. A method according claim 1 further comprising analyzing the speech characteristics of a person using a headset in the office environment by recording the voice of the user through the microphone of the headset and creating and storing the user's voice profile in the bank of user voice profiles.

8. A method according to claim 1 further comprising recording a small sample of speech along with the speech level mapping, subsequently identifying the speaker by listening to the small sample of recorded speech.

9. A method according to claim 1 further comprising improving the voice profile databank by adding new voice profiles or voice profile characteristics based on mapped voice samples.

10. A noise indicator system for identifying one or more noisy person(s) speaking in an open office or other open workplace environment comprising one or more microphones, a voice analyzer configured for analyzing voices recorded by the microphone(s), a noise level estimator configured for estimating the noise level of the voices, a data logging unit configured for recording and storing voice level data, a voice mapping unit configured for comparing recorded voice data with voice data stored in a voice profile data bank.

11. A noise indicator system according to claim 10, further comprising a data exchange interface for connecting and exchanging recorded voice data with external devices.

12. A noise indicator system according to claim 10, further comprising a noise indicator housing and wherein the microphone(s) are mounted either in the noise indicator housing or as external microphones connected to the noise indicator housing either by cable or wirelessly.

13. A noise indicator system according to claim 10, wherein the voice profile databank is connected to a voice sample database.

14. A noise indicator system according to claim 10, wherein the voice profile databank and/or the voice sample database are stored at a remote server such as at a cloud service.

15. A noise indicator system according to claim 10, further comprising a display for indicating current and/or accumulated noise levels.
